(19) United States
(12) Patent Application Publication
(10) Pub. No.: US 2024/0219231 A1
(43) Pub. Date: Jul. 4, 2024

(54) WAVEGUIDE AND ELECTROMAGNETIC SPECTROMETER

(71) Applicant: Endress+Hauser Optical Analysis, Inc., Ann Arbor, MI (US)

(72) Inventors: Marc Winter, Gelnhausen (DE); Joseph B. Slater, Dexter, MI (US)

(21) Appl. No.: 18/148,564

(22) Filed: Dec. 30, 2022

(51) Int. Cl. G01J 3/02; G01J 3/18; G02B 6/02

(52) U.S. Cl. CPC G01J 3/0294; G01J 3/0208; G01J 3/0221; G01J 3/024; G01J 3/18; G02B 6/02295

(57) ABSTRACT

A photonic crystal waveguide for conveying light with an input end and an output end to supply for an electromagnetic spectrometer includes: an input end having a convex envelope of a cross-section of the waveguide at the input end, which envelope defines a circular shape or a shape of a regular polygon with n1 corners, wherein n1 is a natural number bigger than 3; an output end having a cross-section that defines a slit shape; and a plurality of photonic crystal fibers, wherein an arrangement of the plurality of photonic crystal fibers defines the cross-sections at the input and output ends.

### TECHNICAL FIELD

The present disclosure relates to optical waveguides and electromagnetic spectrometers coupled to such waveguides.

### BACKGROUND

Conventional electromagnetic spectrometers use dispersive or diffractive devices for separating light coming from a probe into its spectral components. However, for not wasting spectral resolution, it is necessary that light impinging onto the dispersive or diffractive device is highly collimated. As a preparation for collimation, light stemming from a source may be collected by a round lens and its cylindrically symmetric energy distribution converted to a slit like energy distribution by an optical arrangement. This optical arrangement in the state of the art may comprise a set of optical lenses or fibers such as shown in US 20220350096 A1 to map the initial energy distribution to a slit-like. However, fiber based optical arrangements suffer from a heavy initial loss due to inefficient light in-coupling due to the fact, that light within fibers is conveyed only within a fiber core, whereas the cladding, which takes a significant part of the area of a cross-section, is rather lossy.

Accordingly, there remains a need for further contributions in this area of technology.

### SUMMARY

An object of the present disclosure therefore is to provide an optical arrangement to supply an electromagnetic spectrometer, which has minimized loss and, therefore, increased efficiency. The object is achieved by a waveguide and an electromagnetic spectrometer as claimed according to the present disclosure.

A photonic crystal waveguide according to the present disclosure for conveying light with an input end and an output end to be used for an electromagnetic spectrometer comprises: a plurality of fibers, each configured for conveying electromagnetic waves, such as light, from the input end to the output end, wherein a convex envelope of a cross-section of the photonic crystal waveguide at the input end defines a circular shape or a shape of a regular polygon with n1 corners, wherein n1 is a natural number larger than 3, wherein a cross-section of the photonic waveguide at the output end defines a slit shape, wherein the fibers are photonic crystal fibers, and wherein the fibers comprise a support structure and uniformly arranged channels within the support structure.

Photonic crystal fibers are not limited to a core when it comes to the capability and capacity of conveying light. Rather, light is transported by the entirety of uniformly arranged channels in a support structure. This configuration greatly improves the transmission of probe light through the waveguide compared to a conventional fiber waveguide.

In an embodiment, a convex envelope of a cross-section of each of the fibers defines a rectangular polygon with n2 corners, wherein n2 is 3, 4 or 6. In that way, the plurality of fibers can be stacked robustly.

In an embodiment, the waveguide comprises two frames, wherein a first frame of the two frames is configured and disposed to position the plurality of fibers the input end, and wherein a second frame of the two frames is configured and disposed to position the plurality of fibers the output end. In that way, the fibers keep their relative position more precisely and more robustly.

In an embodiment, each photonic crystal fiber comprises a confinement structure configured to prevent mutual electronic band structure influencing.

In an embodiment, the output end has a length and a width, wherein the width is less than three diameters of one of the photonic crystal fibers. A thin output end improves the possibility to collimate the light.

In an embodiment, at the output end the photonic crystal fibers are arranged as a one-dimensional array. In that way, collimatability is maximized. In an embodiment, the slit shape is linear.

In an embodiment, the output end is configured to be optically connected with an optical lens, wherein the optical lens has a lens refractive index, and wherein a mean refractive index of the photonic crystal fibers differs from a mean of refractive index of air and the lens refractive index by less than 10%.

The index matching reduces losses due to reflection from surfaces between materials of different refractive index. As used herein, the term optical includes also mid-infrared, near-infrared and near-ultraviolet light wavelengths.

In an embodiment, the output end is configured to be optically connected with an optical lens, wherein the optical lens has a lens refractive index, and wherein the photonic crystal fiber refractive index varies continuously along the photonic crystal fibers. The index matching reduces losses due to reflection from surfaces between materials of different refractive index.

In an embodiment, the photonic crystal fibers are embedded in a shaping element, which shaping element defines the progression of the fibers from the input end to the output end. In that way, the fibers maintain their position rigidly.

In an embodiment the photonic crystal fibers and the shaping element are formed by means of additive manufacturing (e.g., 3D-printing).

An electromagnetic spectrometer according to the present disclosure comprises: a light source adapted to illuminate a probe with light, wherein the light comprises a spectral line and a line width, wherein a ratio of the line width to a wavelength of the spectral line is less than 1/10000; a collector configured to collect light emitted from the probe as probe light; a waveguide according to the present disclosure; a dispersive or diffractive element configured and arranged to separate probe light transmitted from the probe into its spectral components; a detector configured to detect the spectral components of the probe light; and an optical arrangement comprising an optical lens and a collimating lens, wherein the optical lens is configured to diverge the probe light, wherein the collimating lens is configured to collimate the diverging probe light and to convey the diverging probe light to impinge upon the dispersive or diffractive element, and wherein the photonic crystal waveguide is configured and arranged to convey the probe light from the collector to the optical arrangement.

### BRIEF DESCRIPTION OF THE DRAWINGS

The described embodiments and other features, advantages and disclosures contained herein, and the manner of attaining them, will become apparent and the present disclosure will be better understood by reference to the following description of various embodiments of the present disclosure taken injunction with the accompanying drawings, wherein:

FIGS. 1a-1c show an exemplary embodiment of a waveguide according to the present disclosure, including detailed views of input and output ends of the waveguide and of a cross-section of a photonic crystal fiber;

FIGS. 2a-2c show different cross-sections of fibers of embodiments waveguide according to the present disclosure;

FIG. 3a shows a perspective view of an exemplary waveguide according to the present disclosure;

FIGS. 3b and 3c show a detailed views of an inlet end of the waveguide shown in FIG. 3a; and

FIG. 4 shows a schematic of an electromagnetic spectrometer comprising a waveguide according to the present disclosure.

### DETAILED DESCRIPTION

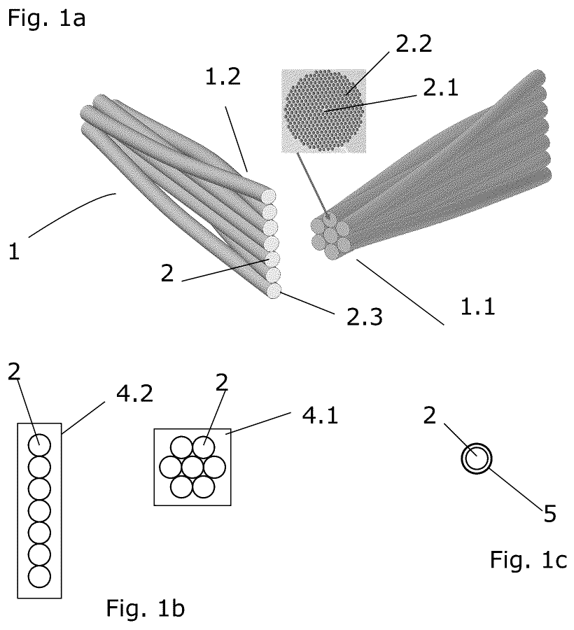

FIG. 1a shows an embodiment of a waveguide 1 for conveying light with an input end 1.1 and an output end 1.2 to be used for an electromagnetic spectrometer viewed from a back side and a front side, respectively, according to the present disclosure. The waveguide comprises as, an example, seven photonic crystal fibers 2, which are arranged in a generally circular fashion at the input end 1.1. In that way, the light of a source (not shown) can be captured effectively without excessive losses, as in many cases light distribution from various known sources is roughly cylindrically symmetric. The fibers 2 at the output end 1.2 are arranged such that the intensity distribution of the light being conveyed through and emitted from the waveguide 1 defines a slit. Therefore, the output ends 1.2 of the fibers 2 are arranged generally linearly. In this way, the fibers 2 map the intensity distribution of probe light at the input end 1.1, which is more or less cylindrically symmetric to an essentially slit-like intensity distribution at the output end 1.2.

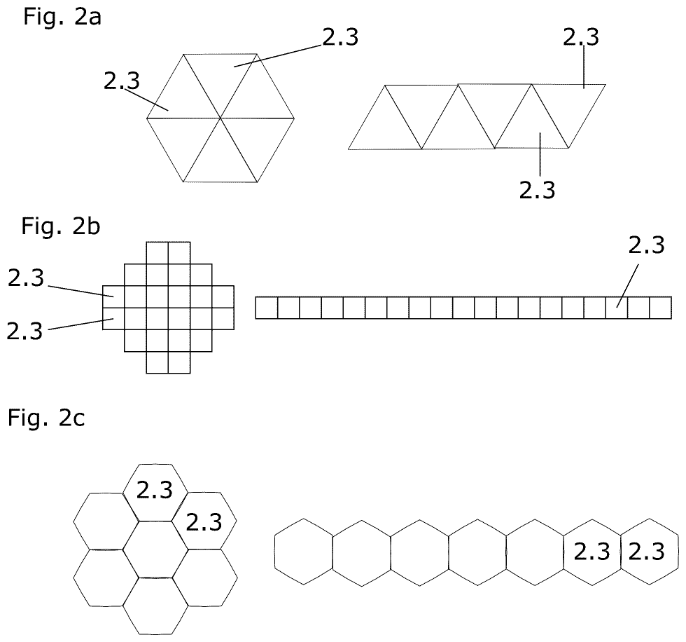

Each of the fibers 2 is a photonic crystal fiber in which the fibers 2 comprise a support structure 2.1 and uniformly arranged channels 2.2 within the support structure 2.1. The support structure 2.1 may be made, for example, from a polymer, a glass or a crystal. The uniform arrangement of the channels 2.2 causes the fibers 2 to have a band structure. The plurality of uniformly arranged channels 2.2 convey probe light much better than a single fiber core of a conventional optical fiber. A convex envelope of a cross-section of each photonic crystal fiber 2 can be circular, as shown in FIG. 1, or assume shapes as shown in FIGS. 2a-2c.

The number of photonic crystal fibers 2 is not limited to seven fibers. A person having ordinary skill in the art will adapt the number according to the needs of a specific implementation of the present disclosure. For example, with twelve more fibers 2 a second ring of fibers 2 surrounding the shown fiber arrangement at the input end 1.1 could be completed. The slit-like arrangement at the output end 1.2 may be formed by one column of fibers 2 or more columns.

The photonic crystal fibers 2 may be held together and/or positioned by frames. As shown in FIG. 1b, a first frame 4.1 may hold the fibers 2 at the input end 1.2, and a second frame 4.2 may hold the fibers 2 at the output end 1.2, each in the desired configuration.

Photonic crystals are engineered, highly ordered nanostructures with a periodic arrangement of materials that possess a periodically modulated dielectric constant and have different refractive indices, with the properties of confining and controlling the propagation of light owing to the existence of photonic band gap. Photonic crystals could have period in one, two or three dimensions (3D). The photonic crystal fibers 2 are optical grade fibers composed of such photonic crystal materials.

Photonic crystal fibers are not limited to a core when it comes to the capability and capacity of conveying light. Rather, light is transported by the entirety of the uniformly arranged channels 2.1 in a support structure 2.2. This effect greatly improves the transmission of probe light through the waveguide compared to a conventional fiber waveguide.

As shown in FIG. 1c, each of the photonic crystal fibers 2 may comprise a confinement structure 5 configured to prevent mutual electronic band structure influencing. In this way, transmission of the waveguide may be more stable over time.

FIGS. 2a to 2c show exemplary envelopes of cross-sections 2.3 of a waveguide 1 according to the present disclosure, in which advantages with respect to stackability are illustrated. In a first example shown in FIG. 2a, the fibers 2 may have a triangular shape. In that way, the input end 1.1 may be configured as a hexagon with good, efficient coverage of source light. At the output end 1.2, the fibers 2 may be configured slit-like by stacking them interlaced, side-by-side as shown on the right of FIG. 2a.

In the example as shown in FIG. 2b, the fibers 2 may have a square shape and can be configured in roughly square or generally octagonal fashion, for example, at the input end 1.1. The output end 1.2 may again be configured linearly, for example, by an arrangement of the fibers 2 as a single column. FIG. 2c shows an arrangement of fibers 2, whose envelope of cross-section generally defines a hexagon. Similar to FIGS. 2a and 2b, the input end 1.1 may be configured to loosely follow a circular form, and the output end 1.2 linearly.

One advantage of the configurations, as shown in FIGS. 2a to 2c, is that the fibers 2 can be stacked against each other without any gaps in between, such that loss of the probe light at the input end 1.1 is minimized.

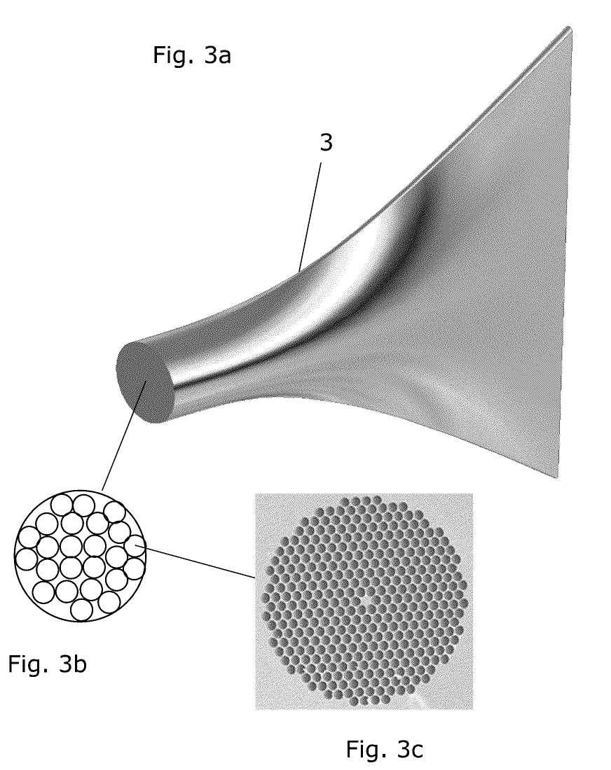

In an embodiment as shown in FIG. 3a, the photonic crystal fibers 2 may be embedded in a shaping element 3, which shaping element 3 defines the progression of the fibers 2 from the input end 1.1 to the output end 1.2. The fibers 2 and/or the shaping element may be formed, for example, by additive manufacturing (e.g., 3D printing, fused deposition modelling, fused fiber fabrication, selective laser sintering, selective laser melting, material and binder jetting processes). The fibers 2 in such a waveguide 1 are robust against external forces, such that transmission properties remain very stable. As shown in FIG. 3b, a cross-section of the shaping element 3 comprises of a plurality of fibers 2, wherein each fiber 2 is a photonic crystal fiber as illustrated in FIG. 3c.

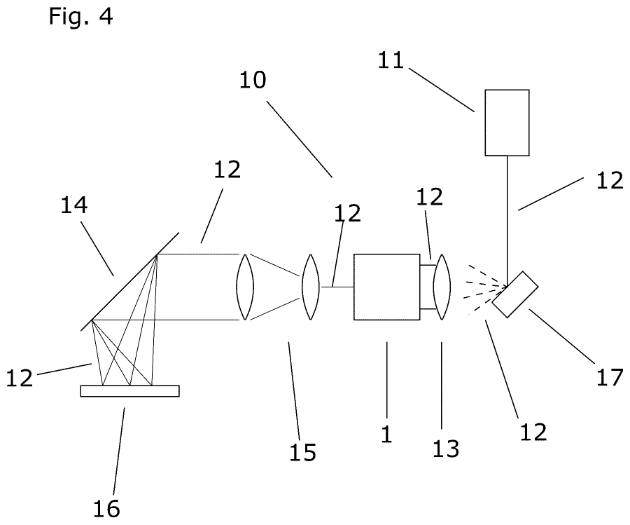

FIG. 4 illustrates an exemplary electromagnetic spectrometer, including a waveguide according to the present disclosure. As shown, the electromagnetic spectrometer 10 includes a light source 11 configured and arranged to illuminate a probe 17 with light 12. Light 12 being transmitting by the probe 17 is collected by a collector 13 and input in a photonic crystal waveguide 1 as described above.

The photonic crystal waveguide 1 maps the collected light to a slit-like output which is collected and collimated by an optical arrangement 15. Such an optical arrangement may comprise, as shown in FIG. 4, two lenses, a first one for diverge light output from the waveguide 1 and a second for collimating the diverging light and conveying the light onto a dispersive or diffractive element 14. The dispersive or diffractive element 14 may be, for example, a grating, a prism or such alike. The dispersive or diffractive element 14 separates the light 12 stemming from the probe 17 into its spectral components, such that the probe light can be interpreted by the detector 16.

In at least one embodiment, the spectrometer may be of a Raman type, for example, configured to perform Raman spectroscopic analysis.

Claimed is:

1. A photonic crystal waveguide for guiding light configured for an electromagnetic spectrometer, the waveguide comprising:
a plurality of fibers, each configured to convey light from an input end to an output end thereof, wherein a first convex envelope of a cross-section of the waveguide at the input end defines a first shape, and wherein a second convex envelope of a cross-section of the waveguide at the output end defines a slit shape,
wherein each fiber is a photonic crystal fiber comprising a support structure and uniformly arranged channels within the support structure.

2. The waveguide of claim 1, wherein the first shape is a generally circular shape.

3. The waveguide of claim 1, wherein the first shape is a polygonal shape of a regular polygon with n1 corners, wherein n1 is a natural number larger than 3.

4. The waveguide of claim 1, wherein a convex envelope of a cross-section of each of the fibers defines a rectangular polygon with n2 corners, wherein n2 is 3, 4 or 6.

5. The waveguide of claim 1, further comprising:
a first frame configured to position the plurality of fibers at the input end to form the first convex envelope; and
a second frame configured to position the plurality of fibers at the output end to form the second convex envelope.

6. The waveguide of claim 1, wherein each fiber comprises a confinement structure configured to prevent mutual electronic band structure influencing.

7. The waveguide of claim 1, wherein the output end has a length and a width, wherein the width is less than three diameters of any one of the fibers of the plurality of fibers.

8. The waveguide of claim 7, wherein at the output end the plurality of fibers are configured in a one-dimensional array.

9. The waveguide of claim 1, wherein the slit shape is linear.

10. The waveguide of claim 1, wherein the output end is configured to be optically connected with an optical lens, the optical lens having a lens refractive index, wherein a mean refractive index of the plurality of fibers differs from a mean of refractive index of air and the lens refractive index by less than 10%.

11. The waveguide of claim 1, wherein the output end is configured to be optically connected with an optical lens, the optical lens having a lens refractive index, wherein a fiber refractive index varies continuously along each fiber of the plurality of fibers.

12. The waveguide of claim 1, wherein the plurality of fibers is embedded in a shaping element, which shaping element defines a progression of the waveguide from the input end to the output end.

13. The waveguide of claim 12, wherein the shaping element is fabricated by an additive manufacturing process.

14. The waveguide of claim 1, wherein each photonic crystal fiber of the plurality of fibers is fabricated by an additive manufacturing process.

15. A spectrometer comprising:
a light source adapted to illuminate a probe with light, wherein the light comprises a spectral line and a line width, wherein a ratio of the line width to a wavelength of the spectral line is less than 1/10000;
a collector configured to collect light emitted from the probe as probe light;
a photonic crystal waveguide according to claim 1;
a dispersive or diffractive element configured to separate the probe light into its spectral components;
a detector configured to detect the spectral components of the probe light; and
an optical arrangement comprising an optical lens and a collimating lens, wherein the optical lens is configured to diverge the probe light, wherein the collimating lens is configured to collimate the diverging probe light and to convey the diverging probe light to impinge upon the dispersive or diffractive element,
wherein the waveguide is configured and arranged to convey the probe light from the collector to the optical arrangement.

16. The spectrometer of claim 15, wherein the dispersive or diffractive element is a grating or a prism, and wherein the collector is one or more additional optical lenses.

17. The spectrometer of claim 15, wherein a convex envelope of a cross-section of each fiber defines a rectangular polygon with n2 corners, wherein n2 is 3, 4 or 6,
wherein the first shape is a generally circular shape, or
wherein the first shape is a polygonal shape of a regular polygon with n1 corners, wherein n1 is a natural number larger than 3.

18. The spectrometer of claim 15, The waveguide of claim 1, further comprising:
a first frame configured to position the plurality of fibers at the input end to form the first convex envelope; and
a second frame configured to position the plurality of fibers at the output end to form the second convex envelope.

19. The spectrometer of claim 15, wherein each fiber comprises a confinement structure configured to prevent mutual electronic band structure influencing.

20. The spectrometer of claim 15, wherein the plurality of fibers is embedded in a shaping element, which shaping element defines a progression of the waveguide from the input end to the output end.
